(19) United States
(12) Patent Application Publication
(10) Pub. No.: US 2008/0046532 A1
(43) Pub. Date: Feb. 21, 2008

(54) Delayed instant messaging for assured communication

(75) Inventors: Rami Caspi, Sunnyvale, CA (US); Andrew Mason, Sunnyvale, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/506,744

(22) Filed: Aug. 18, 2006

(51) Int. Cl. H04M 1/64; G06F 15/16

(52) U.S. Cl. 709/207; 379/88.17; 709/206

(57) ABSTRACT

In some embodiments, a computer-readable storage medium containing a set of instructions for a general purpose computer having a user interface may include one or more of the following features: (a) an instant messaging session associated with said user interface for permitting an originating party to communicate with a destination party in real time comprising, (i) an input messaging routine associated with the instant messaging session for allowing the originating party to input a message to be sent to the destination party, (ii) a delay messaging routine associated with the input messaging routine for placing an outgoing instant message in a buffer for a predetermined time frame, and (iii) a send messaging routine associated with the delay messaging routine for sending the outgoing instant message to the destination party after the predetermined time frame has passed.

### FIELD OF THE INVENTION

The present invention generally relates to the field of computer systems for providing real-time instant messaging. Specifically, the present invention relates to a method and apparatus for sending instant messages. More specifically, the present invention relates to delaying an instant message from being sent.

### BACKGROUND OF THE INVENTION

Instant Messaging (IM) is becoming more and more common in the professional and corporate environment. People are being more accustomed to having an immediate communication mechanism with others. At times with multiple people simultaneously.

However, the immediacy and multi-tasking nature of IM can also provide problems in a business environment. In the rush to be responsive it is easy to make grammatical or typographical errors that can lead to confusion or embarrassment. In addition, when multiple IM input windows are open it can be easy to accidentally respond on an incorrect IM thread. However, when an error is made it is too late. The only way to cover for such errors is to apologize and re-send the IM. However, the incorrect message has already been sent and potential damage been done.

Current IM systems transmit the message immediately, giving the originator no time to correct. Therefore, there is a need for a system that helps the user prevent instant messages with grammatical or spelling errors from being sent. Before the originator has time to correct the errors.

### SUMMARY OF THE INVENTION

In some embodiments, a computer-readable storage medium containing a set of instructions for a general purpose computer having a user interface may include one or more of the following features: (a) an instant messaging session associated with said user interface for permitting an originating party to communicate with a destination party in real time comprising, (i) an input messaging routine associated with the instant messaging session for allowing the originating party to input a message to be sent to the destination party, (ii) a delay messaging routine associated with the input messaging routine for placing an outgoing instant message in a buffer for a predetermined time frame, and (iii) a send messaging routine associated with the delay messaging routine for sending the outgoing instant message to the destination party after the predetermined time frame has passed.

In some embodiments, an apparatus for conducting instant messaging may include one or more of the following features: (a) means for inputting an instant message, (b) means for delaying the message for a predetermined amount of time when an originating party sends the message, (c) means for sending the message to a destination party in real time after the predetermined amount of time has expired, and (d) a means to correct the instant message when the instant message is delayed.

In some embodiments, a method for instant messaging from an originating party to a destination party may include one or more of the following steps: (a) receiving inputted instant messaging data from a user interface, (b) processing inputted instant messaging data, (c) storing the instant messaging data on a storage medium, (d) delaying the instant messaging data for a predetermined amount of time when the originating party sends the message, (e) sending the instant message data to a destination party in real time after the predetermined amount of time has expired, (e preventing the instant messaging data from being sent if the originating party identifies an error with the instant messaging data, (g) correcting the instant messaging data with the error, (h) sending the corrected instant message.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 shows a block diagram of a system according to some embodiments of the invention;

FIG. 2 shows a screen shot of an instant messaging program according to some embodiments of the present invention;

FIG. 3 shows a block diagram of a system according to some embodiments of the present invention;

FIG. 4 shows a flow chart diagram of a system according to some embodiments of the present invention;

FIG. 5 is a block diagram of the internal architecture of a computing, device according to some embodiments of the invention.

### DETAILED DESCRIPTION OF THE INVENTION

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

Instant messaging is a form of real-time communication between two or more people based on typed text. This is in direct contrast to email which is not real time. The text is conveyed via computers connected over a network such as the Internet. Instant messaging requires the use of a client program that connects to an instant messaging service and differs from e-mail in that conversations are then able to happen in realtime. Most services offer a presence information feature, indicating whether people on one's list of contacts are currently online and available to chat. This may be called a contact list.

An embodiment of the present invention allows a user to avoid IM errors by giving them extra time to detect the errors and prevent the transmission of the IM. This embodiment allows a user to effectively “take back” an IM that has already been sent by deferring the transmittal of the IM with a configurable delay. Between the time the “send” button on the original IM has been pressed and the actual sending of the IM to the other user(s), the originator has enough time to cancel the final delivery of the IM.

The idea is to add a delay buffer to the sequence of sending an IM.

The user types the IM as usual and presses the send key. The normal user experience for the IM is followed (e.g., in most IM sessions, the IM is copied to the upper section of the IM conversation indicating that it has been sent). However, although it appears as if it has been sent, the message is actually copied to a buffer and is not actually transmitted until after a user configured number of seconds, for example five seconds.

This delay gives the user a second chance to look at what has been typed to ensure that it is correct and being sent to the right party. If it is OK, then the message will arrive at the destination. The users on both sides will not see or feel any difference in the way IM works today, since typing an IM usually takes longer than five seconds. If the user desires, then the delay can be configured (for example between 1 and 10 seconds) to match their personal preferences and typing speeds. If, however, the user has made an error then they can click on the problematic text in the upper section and this will cancel the message transmission. The message text will be copied back to the input area for subsequent modification. Further, a delay buffer can be added as a patch to all the existing IM applications.

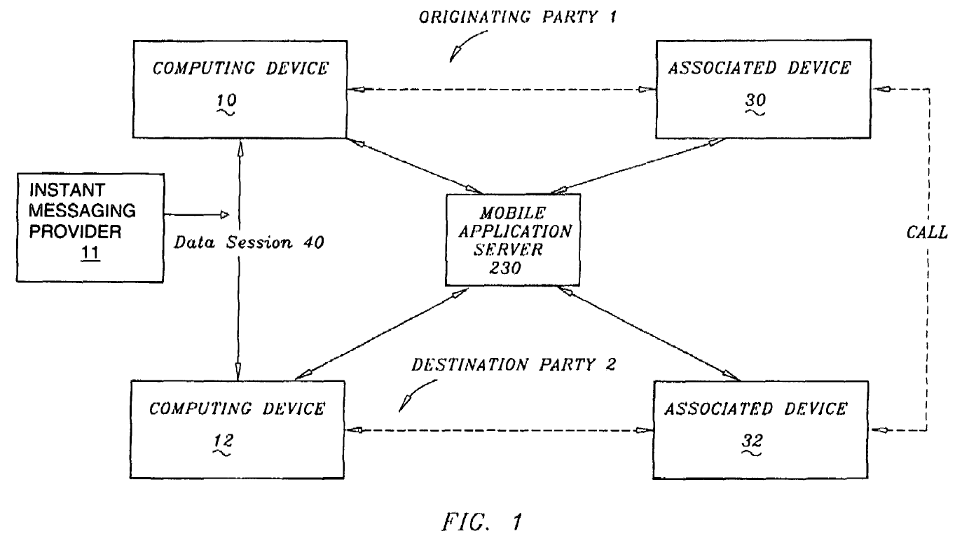

With reference to FIG. 1, a block diagram of a system according to some embodiments is shown. An originating party 1 is shown utilizing a computing device 10 and associated device 30. The computing device contains a processor, memory, an input device, and an output device as are well known in the art. An instant messaging provider 11 can supply software for an instant messaging session 40 between the originating party 1 and a destination party 2 is illustrated. Destination party 2 could also utilize a computing device 12 and associated device 32. The associated device 30 is “associated” with the party 1 and not necessarily with the computing device 10. Likewise, the associated device 32 is associated with the party 2 and not necessarily the computing device 12. Also illustrated is a mobile application server 230 which is described in more detail below. Some embodiments are generally described below with respect to FIG. 1, with more detailed descriptions thereof to follow. The words “party” and “participant” or “parties” and “participants” both have the same intended meaning of one or more individuals or groups involved in a data session, and are used interchangeably throughout.

Computing devices 10 and 12 can be computer systems or similar devices capable of participating in a data session using an instant messaging application such as MSN Messenger™. The IM session 40 is initiated by a user either on computing device 10, computing device 12, or associated devices 30 and 32 and may include definitions/locations of the participants and nicknames. This may include parties 1 and 2 utilizing an associated device (shown as devices 30 and 32) such as a cellular telephone. The establishment of a messaging or collaboration session is well-known in the art and not discussed in further detail.

In some embodiments, IM session 40 can make use of an application such as OpenScape™ (a communications suite developed by Siemens AG) service which configures and manages IM session 40. The secondary application communicates with mobile application server 230 such as an IMS Server (IP Multimedia Subsystem) or other similar mobile application server. The IMS Server is an application server developed by Siemens AG for transacting data with mobile communication devices. The maintenance of the list of parties can also be handled by such applications running on either computing device 10 or 12, mobile application server 230 or even on associated devices 30 and 32

Associated devices 30 and 32 can be an analog cellular telephone and/or a digital cellular telephone, or satellite-based mobile phone or any wireless communication device which has IM capability. In some embodiments, the associated device 30 may be a 2G, 2.5G, 3G, or 3gPP enabled device.

Mobile application server 230 is an application server which may be present in or accessible by a base station of a cellular network or other communications relaying and networking center. One example is IMS (see description above) which allows inter-working and communication amongst IP-based networks, cellular technologies (such as GSM/GPRS) and wired telephony technologies (such as PSTN) and thus enables a rich variety of data (such as instant messages). The mobile application server 230 may also be available to computing device 10 or 12 via a data network such as the Internet.

In accordance with various embodiments of the invention, computing device 10 would be utilized by a party to participate in IM session 40. IM session 40 may present or make available to either party 1 or 2 a list of all of parties. Included in this list may be the name of each.

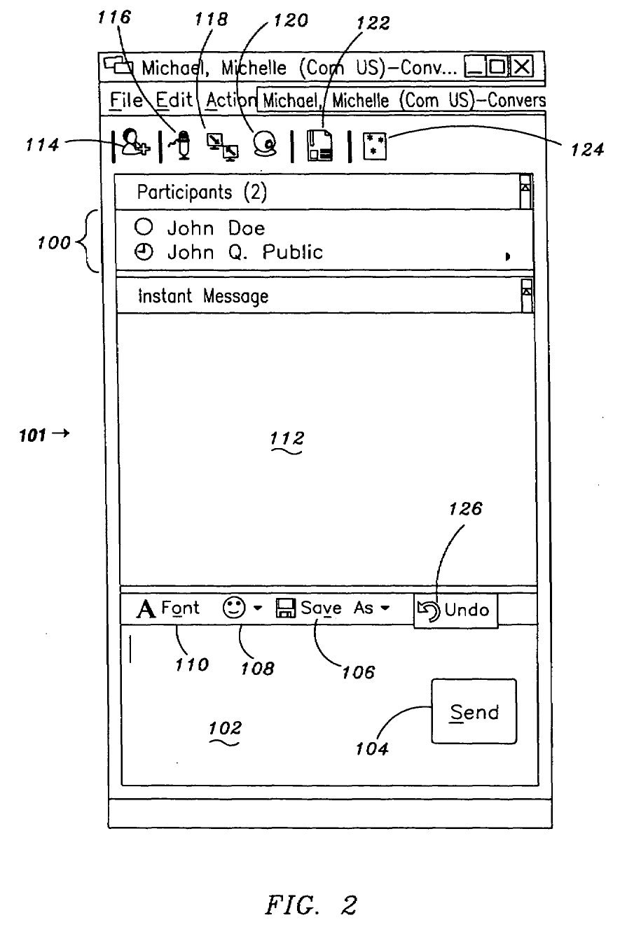

In accordance with at least some embodiments of the invention, the originating party 1 is presented via computing device 10 or via associated device with a list or selection toggle which includes an identifier for destination party 2. The identifier could be any combination of a name, email, or nickname. For example, in FIG. 2 the participants are shown in window 100.

With reference to FIG. 2, a screen shot of an instant messaging program according to some embodiments of the present invention is shown. A user is able to type a message in box 102 using a graphical user interface 101 and send the message by clicking on button 104. A user can save an IM using button 106, add an emoticon using button 108, or change the font of the message using button 110. Received messages from other participants are displayed in window 112. The user can add more participants to the IM session using button 114, utilize voice communications with button 116, initiate collaboration with other participants using button 118, send a picture with button 120, send an attachment with button 122, and can begin a new IM session with button 124. Button 126 provides a unique improved functionality for embodiments of the present invention. Undo button 126 allows the IM user to delay an IM in a buffer (discussed in more detail below) before sending the IM to the intended recipient(s). This delay allows the user to view the newly sent IM for grammatical and spelling errors and if any are within the text the user simply clicks on undo button 126 to retrieve the IM and correct the errors. Undo button 126 can also be used if the user notices that the IM has been sent to an incorrect recipient. Thus undo button 126 assists the user in preventing embarrassing situations due to errors in the text or incorrect recipients. In use, when the user has completed the text to be sent, they click on send button 104. This causes undo button 126 to blink, perhaps in a green color, to notify the user that they have a short amount of time in which to recall the IM before the IM is sent. After this predetermined amount of time, the IM is sent which causes undo button 126 to blink in a different color, perhaps red, indicating to the user that it is too late to recall the IM and that the IM has been sent to the recipient. Other methods of user notification to recall can be used, such as a pulsing noise notification, an audio voice telling the user time has expired, or a visual text box indicating time has expired without departing from the spirit of the invention.

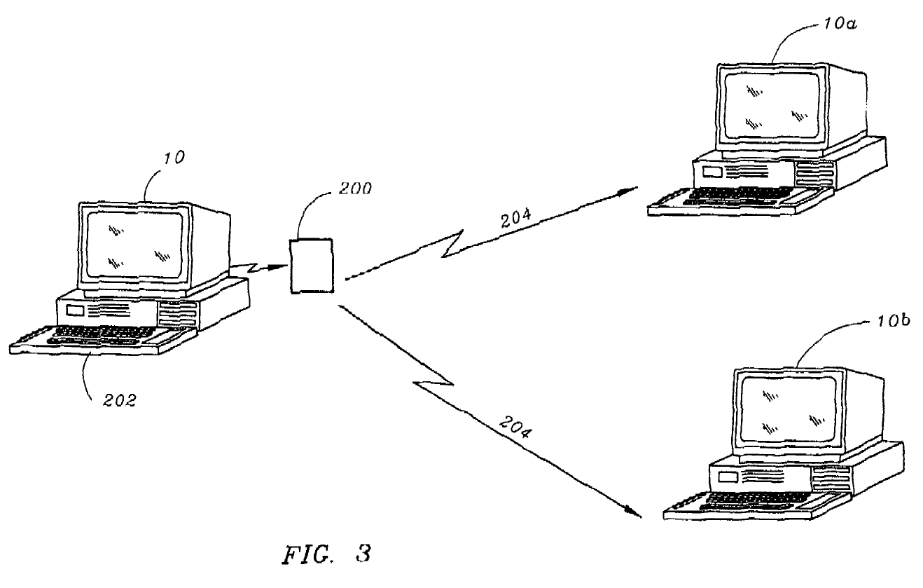

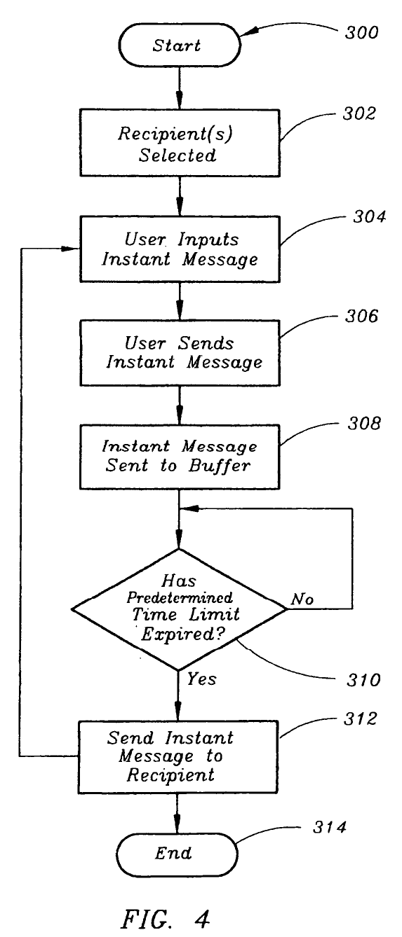

With reference to FIGS. 3 and 4, a block and flow chart diagram of a system according to some embodiments of the present invention is shown. In operation, a user begins an IM session 301 by running the IM software at state 300. The user would then select the recipients they would like the IM to go to at state 302. The user can input an IM at user interface 202 into computer system 10 running IM software at state 304. As discussed above, when the user is ready to send the IM they would click on send button 104 at state 306. This sends the IM to buffer 200 where it is stored for a period of time at state 308. The buffer is shown outside of computer system 10; however, this is only for clarity and would most likely be housed in computer system 10. The period of time the IM is delayed can be set by the IM software provider or could be manually set by the user. The period of time can be any amount of time, but the inventors have found that a period of greater than 0 seconds to 10 seconds helps retain the real time aspect for the user. This has also proved long enough time for the user to read the message sent and determine if it needs to be recalled. The IM program inquires as to whether the predetermined amount of time has expired at state 310. If the predetermined amount of time has expired, the IM is sent 204 to an SIP (session initiation protocol) proxy and out to the intended recipients at state 312. If the time has not expired, the IM program continues to inquire if the time has expired. After the message has been sent, the user can draft another instant message at state 304 or decide to end the IM session at state 314.

This system allows a user to effectively “take back” an IM that has already been sent. It also keeps the real time benefits of instant messaging for the user.

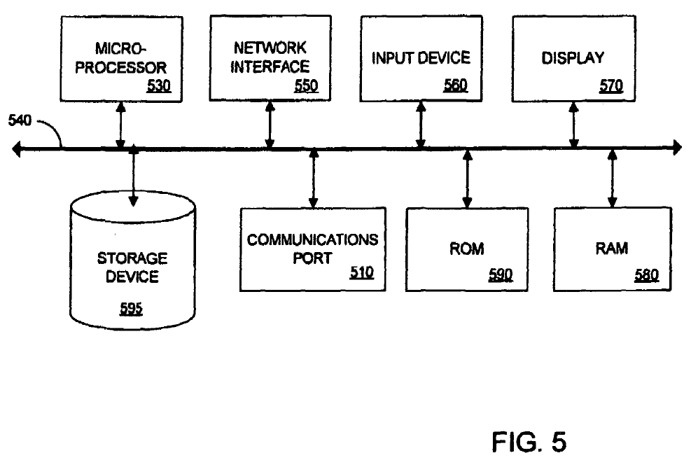

FIG. 5 is a representative block diagram of computing device 10 or mobile application server 230 according to some embodiments. It is understood computing device 10 and/or 12 could be used to execute the functions described above. First, operation as computing device 10 will be described in detail, and then, operation as mobile application server 230 will be described. Many operating details in the description of elements computing device 10, below, can also be applied when those elements combine to operate as mobile application server 230.

Computing device 10 may comprise a single device or computer, a networked set or group of devices or computers, such as a workstation, laptop etc. Computing device 10 is typical of a data session-capable machine. Computing device 10 includes microprocessor 530 in communication with communication bus 540. Microprocessor 530 is used to execute processor-executable process steps so as to control the components computing device 10 to provide functionality according to embodiments of the present invention. Microprocessor 530 may comprise a Pentium™, or Itanium™ microprocessor manufactured by Intel Corporation. Other suitable processors may be available from Motorola, Inc., AMD, or Sun Microsystems, Inc. Microprocessor 530 also may comprise one or more microprocessors, controllers, memories, caches and the like.

Input device 560 and display 570 are also in communication with communication bus 540. Any known input device may be used as input device 560, including a keyboard, mouse, touch pad, voice-recognition system, or any combination of these devices. Input device 560 may be used by a user to input information and commands and select a destination party (parties) to initiate instant messaging.

Display 570 may be an integral or separate CRT display, a flat-panel display or the like. Display 550 is generally used to output graphics and text to an operator in response to commands issued by microprocessor 530.

Display 570 may display presentation data and the like which is used during the instant messaging session.

RAM (Random Access Memory) 580 is connected to communication bus 540 to provide microprocessor 530 with fast data storage and retrieval. In this regard, processor-executable process steps being executed by microprocessor 530 are typically stored temporarily in RAM 580 and executed therefrom by microprocessor 530. ROM (Read Only Memory) 590, in contrast, may provide storage from which data can be retrieved but to which data cannot be stored. Accordingly, ROM 590 may be used to store invariant process steps and other data, such as basic input/output instructions and data used during system boot-up or to control input device 560. One or both of RAM 580 and ROM 590 may communicate directly with microprocessor 530 instead of over communication bus 540, or on separate dedicated busses.

Data storage device 595 stores, among other data, processor-executable process steps of instant messaging session management application discussed with respect to FIG. 4. The process steps and program code of the instant messaging management application and the like may be read from a computer-readable medium, such as a floppy disk, a CD-ROM, a DVD-ROM, a Zip™ disk, a magnetic tape, or a signal encoding the process steps/program code, and then stored in data storage device 595 in a raw, compressed, un-compiled and/or encrypted format. In alternative embodiments, hard-wired circuitry may be used in place of, or in combination with, processor-executable process steps for implementation of the processes described herein. Thus, embodiments are not limited to any specific combination of hardware, firmware and software.

Also illustrated is a network interface 550 which may be a wired or wireless Ethernet interface, a modem interface, and so on. In utilizing the various embodiments of the invention, the network interface 550 may be connected to or to provide or access a high-speed connection to the Internet or an Intranet providing access to the Internet or similar networks. Using such a network or networks, computing device 10 can communicate identifiers of destination parties to mobile application server 230.

Stored in data storage device 595 may also be other elements that may be necessary for operation of computing device 10, such as other applications, other data files, a network server, an operating system, a database management system and “device drivers” for allowing microprocessor 530 to interface with external devices. These elements are known to those skilled in the art, and are therefore not described in detail herein.

FIG. 5 may also represent a mobile application server 230. The mobile application server 230 would use network interface 550 to communicate with computing devices and associated devices, cellular networks, satellite networks and the like. Mobile application server 230 would also run software such as Look-Up/Configure using program code loaded into RAM 580 and executed by microprocessor 530. Code and data for these applications as well as presentation data and the like can be stored on data storage 595 and the like. The mobile application server 230 may also have a connection to a separate cellular, satellite or other wireless networking capability so that it communicate ID information to associated devices which are mobile.

The particular arrangements of process steps described above are not meant to imply a fixed order; embodiments can be practiced in any order that is practicable. The processes described herein may be embodied as program code developed using an object-oriented language that allows the modeling of complex systems with modular objects to create abstractions that are representative of real world, physical objects and their interrelationships. However, embodiments may be implemented in many different ways using a wide range of programming techniques as well as hardwired in hardware systems or dedicated controllers. In addition, in some embodiments, many, if not all, of the elements described above are optional or can be combined into single elements.

Thus, embodiments of the DELAYED INSTANT MESSAGING FOR ASSURED COMMUNICATION are disclosed. One skilled in the art will appreciate that the present teachings can be practiced with embodiments other than those disclosed. The disclosed embodiments are presented for purposes of illustration and not limitation, and the present teachings are limited only by the claims that follow.

What is claimed is:

1. A computer-readable storage medium containing a set of instructions for a general purpose computer having a user interface, the set of instructions comprising:
an instant messaging session associated with said user interface for permitting an originating party to communicate with a destination party in real time comprising:
an input messaging routine associated with the instant messaging session for allowing the originating party to input a message to be sent to the destination party;
a delay messaging routine associated with the input messaging routine for placing an outgoing instant message in a buffer for a predetermined time frame; and
a send messaging routine associated with the delay messaging routine for sending the outgoing instant message to the destination party after the predetermined time frame has passed.

2. The medium of claim 1, wherein the predetermined time frame ranges from greater than 0 seconds to 10 seconds

3. The medium of claim 1, wherein the predetermined time frame is selected by the originating party.

4. The medium of claim 1, wherein the predetermined time frame is determined by an instant messaging routine provider.

5. The medium of claim 1, wherein the user interface is a graphical user interface.

6. The medium of claim 5, wherein the graphical user interface provides a graphical indication when the instant message is being held in the buffer.

7. The medium of claim 6, wherein the graphical user interface provides a graphical indication when the instant message has been sent.

8. An apparatus for conducting instant messaging, comprising:
means for inputting an instant message;
means for delaying the message for a predetermined amount of time when an originating party sends the message; and
means for sending the message to a destination party in real time after the predetermined amount of time has expired.

9. The apparatus of claim 8, wherein the user interface is a graphical user interface.

10. The apparatus of claim 9, wherein the graphical user interface provides a graphical indication when the instant message is being held in a buffer.

11. The apparatus of claim 10, wherein the graphical user interface provides a graphical indication when the instant message has been sent.

12. The apparatus of claim 11, wherein the graphical indication is a graphical button which changes colors when the instant message is delayed and when it has been sent.

13. The apparatus of claim 8, further comprising a means to correct the instant message when the instant message is delayed.

14. A method for instant messaging from an originating party to a destination party, comprising:
receiving inputted instant messaging data from a user interface;
processing inputted instant messaging data;
storing the instant messaging data on a storage medium;
delaying the instant messaging data for a predetermined amount of time when the originating party sends the message; and
sending the instant message data to a destination party in real time after the predetermined amount of time has expired.

15. The method of claim 14, further comprising the step of preventing the instant messaging data from being sent if the originating party identifies an error with the instant messaging data.

16. The method of claim 15, further comprising the step of correcting the instant messaging data with the error.

17. The method of claim 16, further comprising the step of sending the corrected instant message.

18. The method of claim 14, wherein a graphical user interface provides a graphical indication when the instant message is delayed.

19. The method of claim 18, wherein the graphical user interface provides a graphical indication when the instant message has been resent.

20. The method of claim 14, wherein the instant message is held in a buffer to prevent the instant message from being sent for the predetermined amount of time.
